(19) United States
(12) Patent Application Publication
(10) Pub. No.: US 2008/0088123 A1
(43) Pub. Date: Apr. 17, 2008

(54) MAGIC CODE FOR MARKETING AND MEDIUM USING THE SAME

(75) Inventors: Geon-Yong JEON, Seoul (KR); Seung-Hwan LEE, Gyeonggi-do (KR)

Correspondence Address: SNELL & WILMER L.L.P. (Main), 400 EAST VAN BUREN, ONE ARIZONA CENTER, PHOENIX, AZ, 85004-2202, US

(73) Assignee: IMS WON CO., LTD., Seoul (KR)

(21) Appl. No.: 11/627,438

(22) Filed: Jan. 26, 2007

(30) Foreign Application Priority Data
Oct. 14, 2006 (KR) 10-2006-0100048

(51) Int. Cl. B42D 15/00

(52) U.S. Cl. 283/56

(57) ABSTRACT

Herein are disclosed a magic code for marketing and a medium using the magic code. The magic code includes a second design layer in which a character, numeral or symbol pattern is regularly and repeatedly formed in a specific color and some of the character, numeral or symbol patterns are deleted; a third design layer in which boundaries of character, numeral or symbol patterns containing the prize winning message are formed in a color similar to the color of the character, numeral or symbol patterns of the second design layer; a fourth design layer in which dots are formed in a color having a complementary color relationship with the color of the character, numeral or symbol patterns of the second design layer; a fifth design layer in which dots are formed in a color similar to the color of the character, numeral or symbol patterns of the second design layer; and the sixth design layer in which the boundary of the character, numeral or symbol pattern is regularly and repeatedly formed in a color similar to the color of the dots of the fourth design layer. The layers are sequentially stacked one on top of another based on brightness, saturation and complementary color relationships.

### CROSS-REFERENCE TO RELATED APPLICATIONS

This application claims the right of priority based on Korean Patent Application No. 10-2006-0100048 entitled “Magic Code for Marketing and Medium Using the Same,” filed on Oct. 14, 2006, which is incorporated herein by reference and assigned to the assignee herein.

1 Technical Field

The present invention relates generally to a magic code for marketing and a medium using the magic code, and, more particularly, to a magic code for marketing and a medium using the magic code, which provide various types of opportunities to attract customers' attention, so that the effect of attracting customers' attention can be increased off-line, for example, through a promotional coupon, an advertising bill, product wrapping paper, a membership card, printed postal material, a television or a newspaper, and the customers' participation in marketing events can be promoted on-line, for example, using a PC, a PDA or a cell phone, thereby maximizing the profits of corporations, and so that customer information acquired through questionnaires, membership subscriptions or requests for the purchase of products can be used in Customer Relationship Management (CRM) marketing or database marketing, thereby maximizing added value.

2. Background Art

As economic activities via wireless communication networks, including the Internet, increase and competition intensifies in modern society, corporations have made every effort to advertise and promote the sale of products so as to attract customers' attention, and various marketing methods have been developed.

Among these various marketing methods, the most widely used method is a method of attracting customers' attention by awarding prizes to customers. The method is chiefly implemented in the form of a lottery, a quiz, a raffle or a game. The lottery, the quiz, the raffle and the game are fabricated separately, are provided on-line in simple forms, or are put into envelopes and provided to customers. However, customers' reactions to them are not favorable.

Meanwhile, in order to overcome the problems of the above method, a hidden image game piece called a web decoder was developed in the U.S. Hidden image game pieces are disclosed in U.S. Pat. Nos. 5,984,367 and 6,296,900, issued to Thomas L. Barnhart and Joel M. Brooks, and an improved hidden image game piece is disclosed in U.S. Pat. No. 6,406,062, issued to Joel M. Brooks, Dannie Causey and Matthew Montesi. However, those pieces have various fundamental limitations in use.

In detail, in a method of fabricating them, a game piece is formed by combining a first ink pattern having a density ranging from 110 to 180 with a second ink pattern having a density ranging from 90 to 170 on a transparent or translucent body and applying a dull coating. Hidden images can be identified using only a computer monitor or a low light emitting means having a candlepower ranging from 80 to 120.

As a result, the game pieces cannot be used at all without using a light source. Furthermore, there is a critical defect in that, since the monitors of Personal Computers (PCs) vary in brightness, it is very difficult to read the hidden images, therefore the complaint that messages cannot be seen well has been raised by customers.

Furthermore, hidden images can be read only when a color screen, called a net decoder, is located above the web decoder so as to be placed over the net decoder, but it is impossible to read hidden images when the net decoder is located below the web decoder.

Accordingly, these game pieces have a fundamental limitation in that they can be applied only to transparent or translucent media, but cannot be applied to opaque media, including paper material which is widely used as printed marketing media, such as product wrapping paper.

Furthermore, because the patented web decoder method has a simple application of marketing over the Internet, corporations' expectations for promotion and sales are not fulfilled and the method does not create profits. In order to overcome these problems, a new method of attracting customers' attention is demanded.

As a result, the marketing medium that needs to be invented must overcome the above-described disadvantages of the web decoder type hidden image game piece. First, the material of a game piece must not be limited to a transparent or translucent material, but may be an opaque material. Second, the game piece should be able to be used off-line so that prize winning-related results can be verified without using a light source. Third, various mixed colors and various kinds of representational colors can be created so that a prize winning message can be viewed when the game piece is located above the prize winning verification plate as well as when the game piece is located below the prize winning verification plate. Fourth, to apply the game piece to on-line games, which are favored by customers, the game piece is required to exhibit multiple reactions in which the same game piece shows different prize winning-related results according to the color. Fifth, the new game piece must have multiple functions so that opportunities to select prize winning verification plates can be provided to customers and various ways of winning prizes can be created in a digital manner.

### SUMMARY OF THE INVENTION

1. Technical Problem

Accordingly, the present invention has been made keeping in mind the above problems occurring in the prior art, and an object of the present invention is to provide a magic code for marketing and a medium using the magic code, which provide various types of opportunities to attract customers' attention, so that the effect of attracting customers' attention can be increased off-line, for example, through a promotional coupon, an advertising bill, product wrapping paper, a membership card, printed postal material, a television or a newspaper, and the customers' participation in marketing events can be promoted on-line, for example, using a PC, a PDA or a cell phone, thereby maximizing the profits of corporations, and so that customer information acquired through questionnaires, membership subscriptions or requests for the purchase of products can be used in CRM marketing or database marketing, thereby maximizing added value.

2. Technical Solution

In order to accomplish the above object, the present invention provides a magic code for marketing, including a second design layer in which a character, numeral or symbol pattern is regularly and repeatedly formed in a specific color on a black design substrate and character, numeral or symbol patterns placed below a prize winning message are deleted; a third design layer in which boundaries of character, numeral or symbol patterns containing the prize winning message are formed in a color similar to the color of the character, numeral or symbol patterns of the second design layer; a fourth design layer in which dots are formed in a color having a complementary color relationship with the color of the character, numeral or symbol patterns of the second design layer so as to fill insides of the boundaries of the character, numeral or symbol patterns that are formed on the third design layer; a fifth design layer in which dots are formed in a color similar to the color of the character, numeral or symbol patterns of the second design layer so as to fill the inside of the boundary of a character, numeral or symbol pattern that is formed on a sixth design layer; and the sixth design layer in which the boundary of the character, numeral or symbol pattern is regularly and repeatedly formed in a color similar to the color of the dots of the fourth design layer so as to effectively hide the prize winning message; wherein the layers are sequentially stacked one on top of another based on brightness, saturation and complementary color relationships, therefore details of the prize winning message of the intermediate design layer cannot be verified with a naked eye.

3. Advantageous Effects

According to the present invention, there are provided a magic code for marketing and a medium using the magic code, which provide various types of opportunities to attract customers' attention, so that the effect of attracting customers' attention can be increased off-line, for example, through a promotional coupon, an advertising bill, product wrapping paper, a membership card, printed postal material, a television or a newspaper, and the customers' participation in marketing events can be promoted on-line, for example, using a PC, a PDA or a cell phone, thereby maximizing the profits of corporations, and so that customer information acquired through questionnaires, membership subscriptions or requests for the purchase of products can be used in CRM marketing or database marketing, thereby maximizing added value.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the construction of a magic code according to an embodiment of the present invention;

FIG. 2 is a diagram illustrating a process in which the design layers of the magic code of FIG. 1 are stacked one on top of another;

FIG. 3 is a diagram illustrating the construction of a magic code according to another embodiment of the present invention;

FIG. 4 is a diagram illustrating a process in which the design layers of the magic code of FIG. 3 are stacked one on top of another;

FIG. 5 is a diagram illustrating the construction of a magic code according to still another embodiment of the present invention;

FIG. 6 is a diagram illustrating a process in which the design layers of the magic code of FIG. 5 are stacked one on top of another;

FIG. 7 is a diagram illustrating the construction of a magic code according to still another embodiment of the present invention;

FIG. 8 is a diagram illustrating methods of verifying prize winning through on-line games using magic codes according to the present invention and prize winning verification plates on the Internet;

FIG. 9 is diagrams illustrating methods of verifying prize winning off-line using magic codes attached to products and the like and gift certificates provided with prize winning verification plates;

FIG. 10 is diagrams illustrating methods of verifying prize winning on-line using magic codes according to the present invention and prize winning verification plates on the Internet or the like;

FIG. 11 is diagrams illustrating envelopes provided with magic codes according to the present invention;

FIG. 12 is diagrams illustrating methods of verifying prize winning using magic codes according to the present invention and the prize winning verification windows of credit cards or the like; and

FIG. 13 is a flowchart illustrating an on-line marketing method using a magic code according to an embodiment of the present invention.

### DETAILED DESCRIPTION

Preferred embodiments of the present invention will be described in detail with reference to the accompanying drawings below.

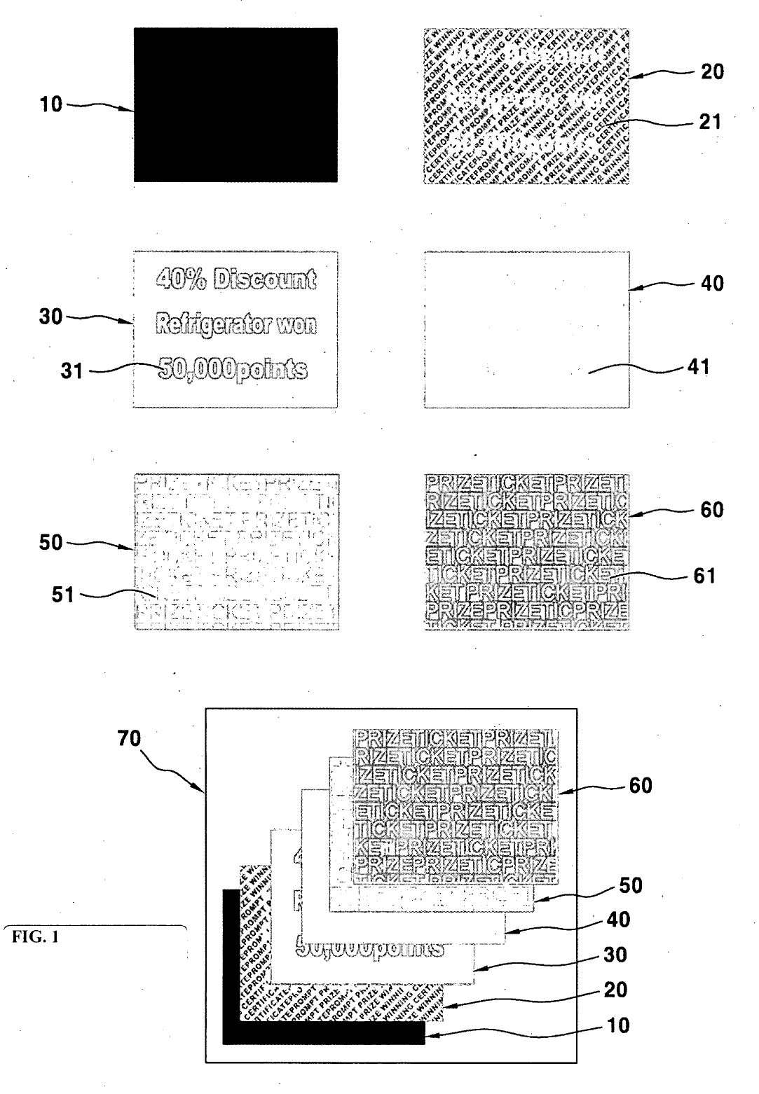

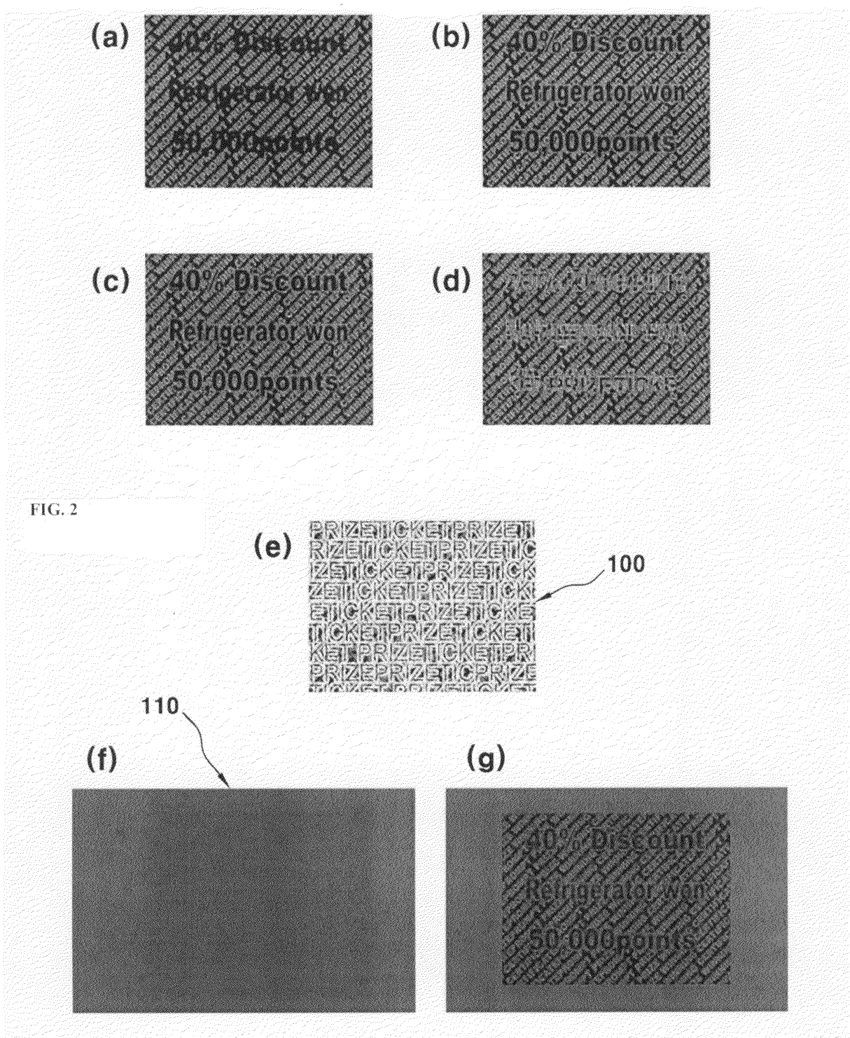

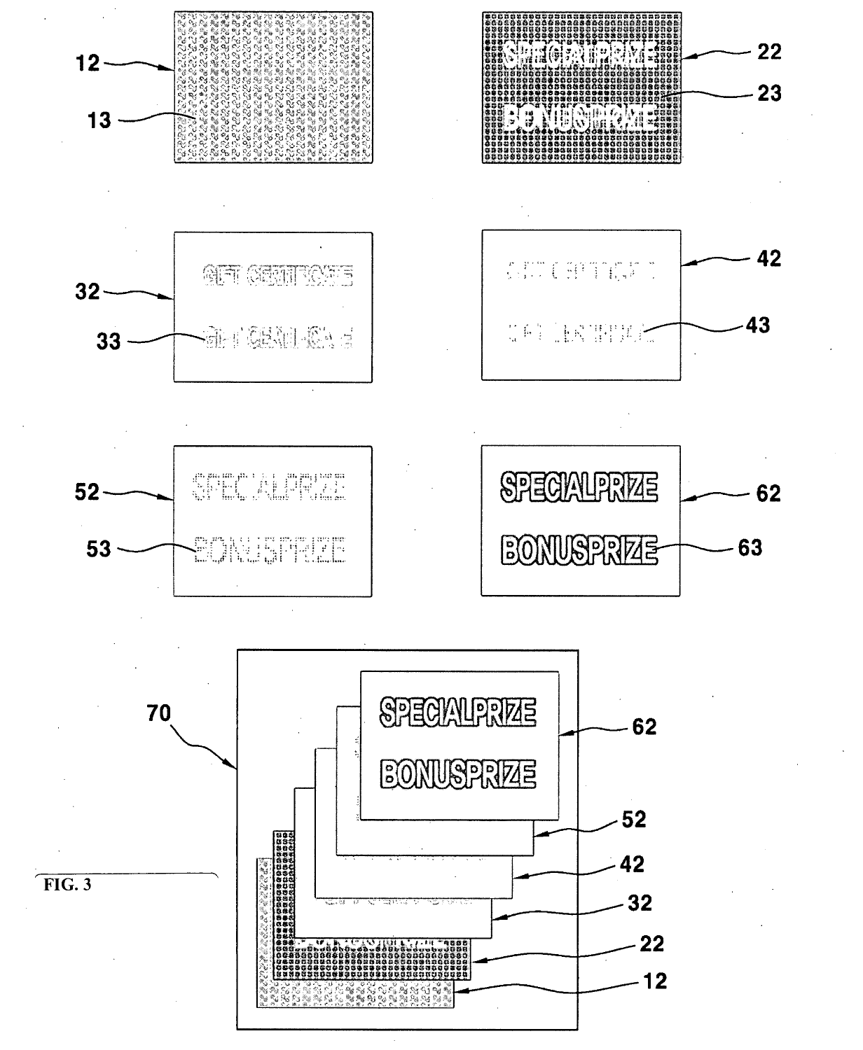

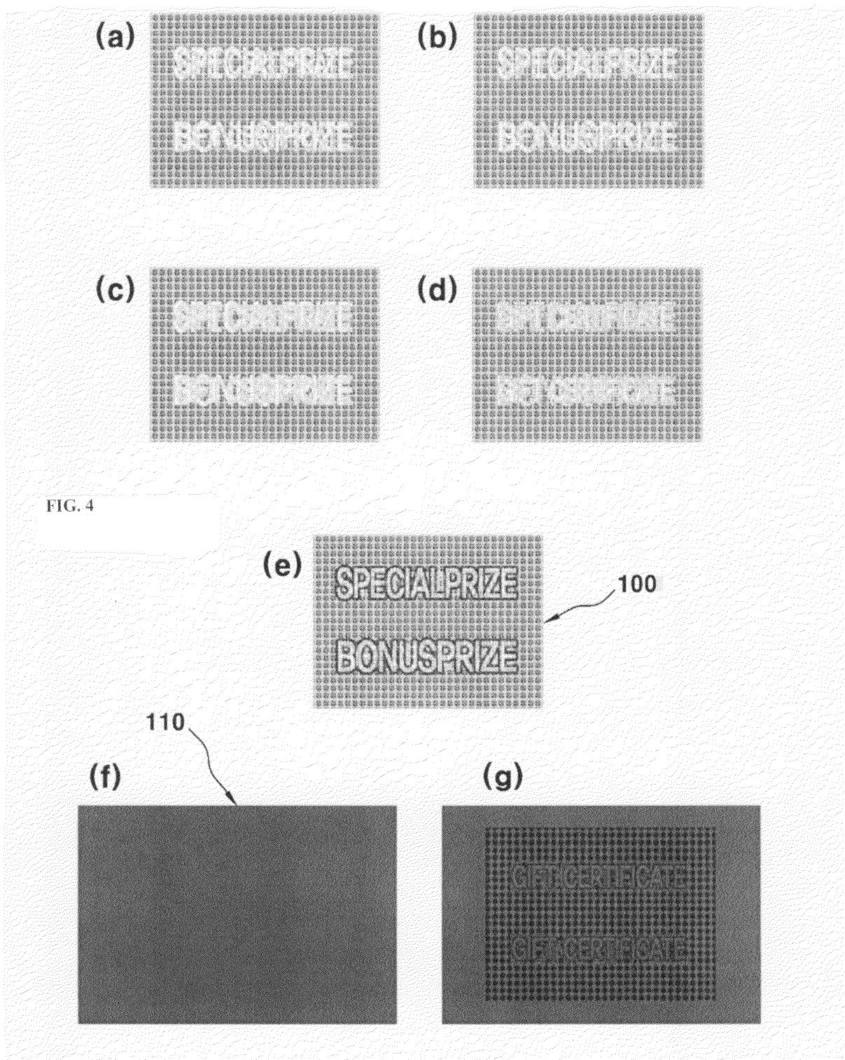

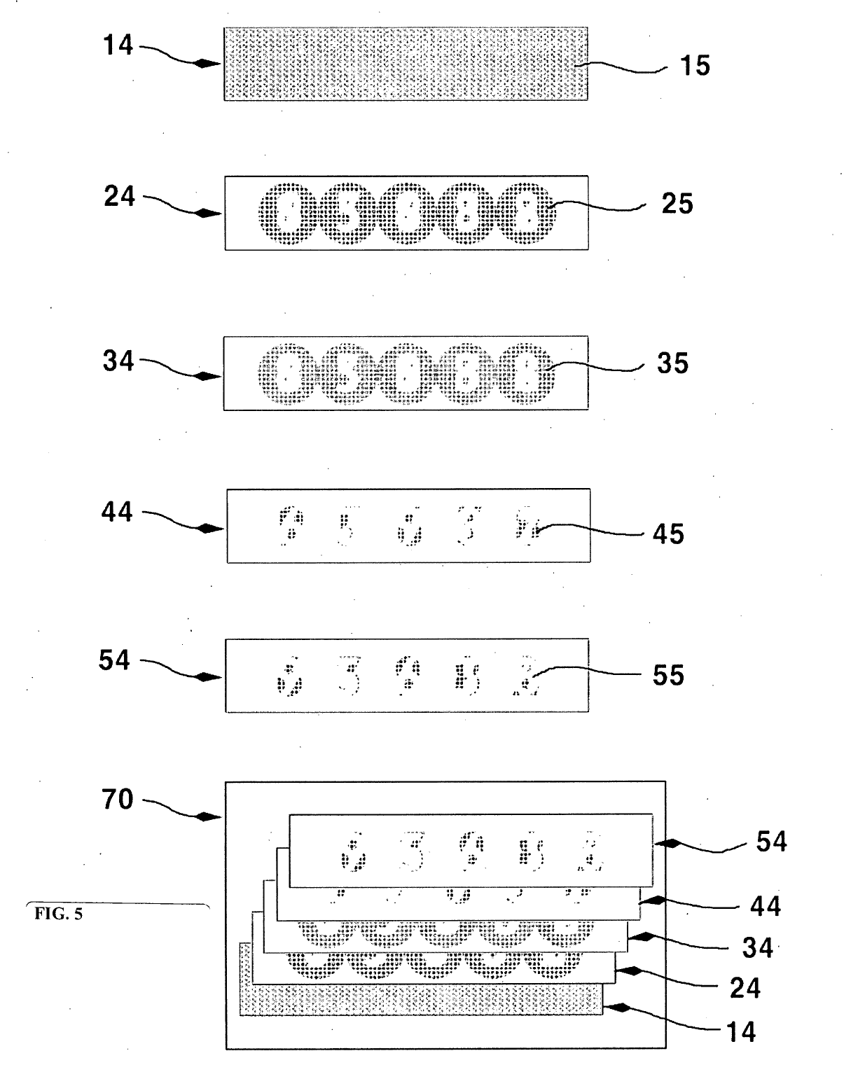

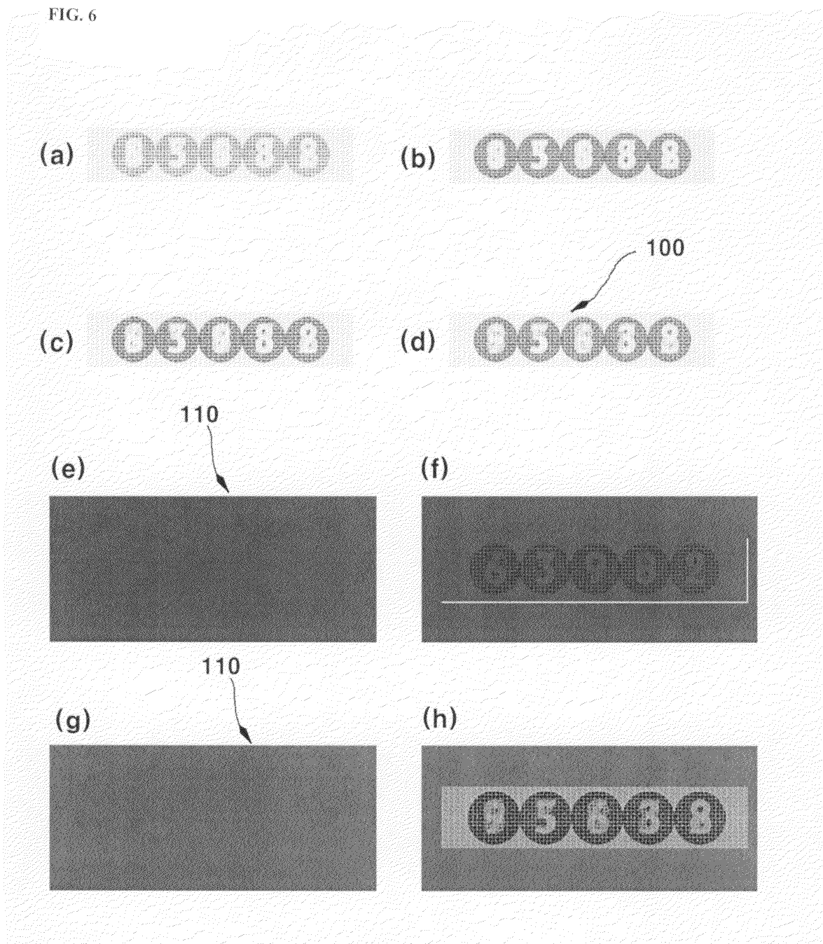

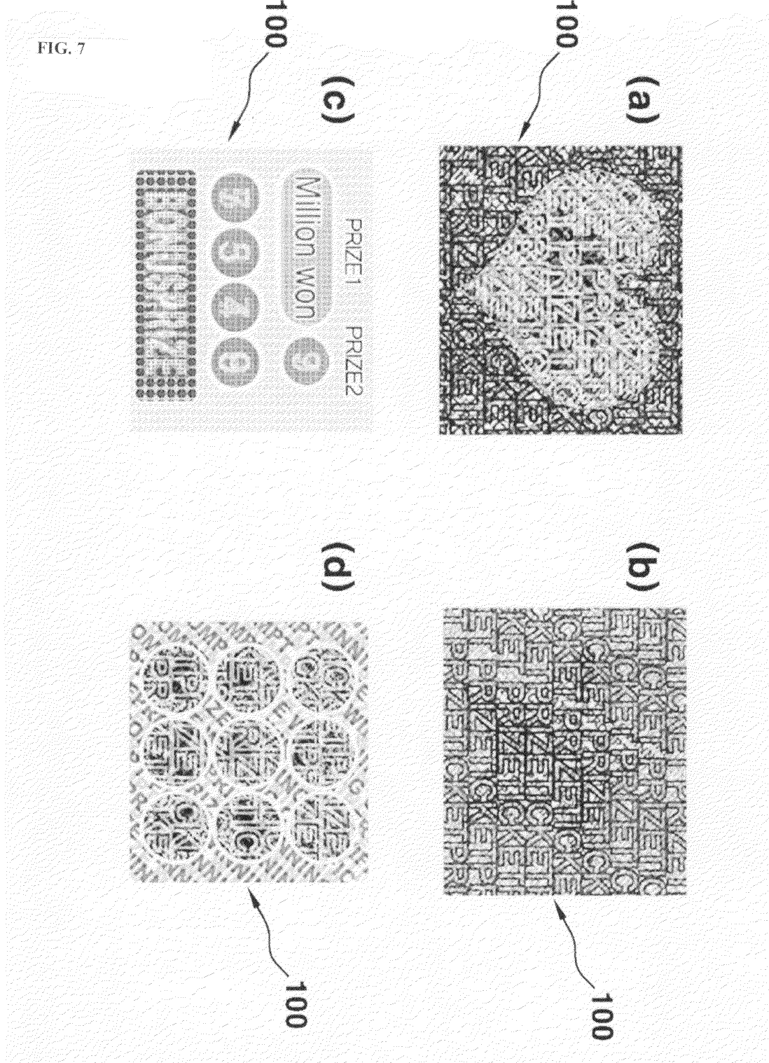

FIG. 1 is a diagram illustrating the construction of a magic code according to an embodiment of the present invention, FIG. 2 is a diagram illustrating a process in which the design layers of the magic code of FIG. 1 are stacked one on top of another, FIG. 3 is a diagram illustrating the construction of a magic code according to another embodiment of the present invention, FIG. 4 is a diagram illustrating a process in which the design layers of the magic code of FIG. 3 are stacked one on top of another, FIG. 5 is a diagram illustrating the construction of a magic code according to still another embodiment of the present invention, FIG. 6 is a diagram illustrating a process in which the design layers of the magic code of FIG. 5 are stacked one on top of another, and FIG. 7 is a diagram illustrating the construction of a magic code according to still another embodiment of the present invention.

As illustrated in FIGS. 1 and 2, in the magic code for marketing 100 of the present invention, multiple design layers and 2˜4 complementary colors are specially combined with each other so as to prevent a prize winning message from being detected through a transparent or opaque printing material 70 with the naked eye. In an embodiment, a second design layer 20, in which a purple character, numeral or symbol pattern 21 is regularly and repeatedly formed and character, numeral or symbol patterns 21 to be placed below the prize winning message of a third design layer 30 are deleted, is placed on a black design substrate 10. The third design layer 30, in which the boundaries 31 of character, numeral or symbol patterns containing the prize winning message are formed in purple, and a fourth design layer 40, in which green dots 41 for filling the insides of the boundaries 31 of the character, numeral or symbol patterns formed on the third design layer 30 are formed, are sequentially placed on the second design layer 20. A fifth design layer 50, in which purple dots 51 for filling the inside of the boundary 61 of a character, numeral or symbol pattern formed on a sixth design layer 60 are formed, and the sixth design layer 60, in which the boundary 61 of the green character, numeral or symbol pattern is regularly and repeatedly formed to effectively hide the prize winning message, are sequentially placed on the fourth design layer 40. As a result, whether a prize has been won is verified according to the color of a prize winning verification plate 110 provided on-line or off-line.

In more detail, FIG. 2(a) illustrates a state in which a second design layer 20 is placed on the black design substrate 10, FIG. 2(b) illustrates a state in which the second design layer 20 and the third design layer 30 are sequentially placed on the black design substrate 10, FIG. 2(c) illustrates a state in which the second design layer 20, the third design layer 30 and the fourth design layer 40 are sequentially placed on the black design substrate 10, FIG. 2(d) illustrates a state in which the second design layer 20, the third design layer 30, the fourth design layer 40 and the fifth design layer 50 are sequentially placed on the black design substrate 10, and FIG. 2(e) illustrates a state in which second to sixth design layers 20, 30, 40, 50, and 60 are sequentially placed on the black design substrate 10. When the red prize winning verification plate 110 of FIG. 2(f) is placed over the magic code 100, as illustrated in FIG. 2(g), after the magic code 100 fabricated as described above has been directly printed on the transparent or opaque printing material 70 or has been displayed on a monitor, the purple color of the magic code 100 remains unchanged, but the characters or the like composed of the green dots 41 that have a complementary color relationship and contain the prize winning-related details have reduced brightness and increased saturation and thus appear black, therefore the prize winning-related details are exposed to the outside.

Meanwhile, the design layers of the magic code 100 of FIG. 1 are printed using a screen method. The screen method is a method of adjusting the concentration of the color and tone of an image by stacking the above-described image layers one on top of another. The screen method is a method of mixing colors using a light mixing method.

In greater detail, the term “screen method” refers to the mixture of light rather than the mixture of dyes. The phenomenon of mixing light is that the larger the number of colors mixed is, the closer the resulting color gets to white (in practice, it is transparent; however, it is called white in the aspect of color representation). Since colors start to be mixed on the basis of black having no light at the time of fabrication, the color of a product fabricated using the screen method, which appears at the time of printing, may be different from that used at the time of fabrication.

Accordingly, when the green dots 41 of the fourth design layer 40 are placed below the purple dots 51 of the fifth design layer 50 at the time of stacking, the resulting color becomes a bright color through a complementary reaction that takes place first. When the red prize winning verification plate 110 is placed over them later, there is concern that the details of a prize winning message are not exposed to the outside, therefore it is preferable to delete green dots 41 and purple dots 51 of the fourth and fifth design layers 40 and 50 that are placed above or below each other, and then place the fifth design layer 50 on the fourth design layer 40.

Here, the color of the prize winning verification plate 110 and the colors of the characters of the design layers are not limited to the above-described combination of colors, but all colors can be used, as long as they can hide the details of a prize winning message and have a complementary color relationship with each other. The design layers are not limited to those printed on the printing material 70, but they may be stored in a recording medium in the form of electronic files and be provided via the WEB or WAP using a PC, PDA or mobile phone or through Internet E-mail, a cell phone SMS or a cell phone MMS, which are on-line transmission media.

Furthermore, when the magic code 100 is viewed with the naked eye, it is preferred that the sizes of characters printed on the design layer be different so as to effectively hide prize winning-related details. In the magic code 100 using the transparent printing material 70, the prize winning verification plate 110 may be placed under the magic code 100. In contrast, in a magic code 100 using the opaque printing material 70, whether a prize has been won can be verified when the transparent prize winning verification plate 110 is placed over the magic code 100. Accordingly, unlike the conventional game method, the present method is not limited to the case where the printing material 70 is transparent or translucent.

As illustrated in FIGS. 3 and 4, in a magic code for marketing 100 according to another embodiment of the present invention, a second design layer 22, in which a pattern 23 is regularly and repeatedly formed in two colors, that is, in red and green and then patterns 23 of the second design layer 22 to be placed below the message of a third design layer 32 and/or the message of a sixth design layer 62 are deleted, is placed on a first design layer 12, in which a yellow pattern 13 is regularly and repeatedly formed. The third design layer 32, in which the boundaries 33 of characters, numerals or symbols containing a prize winning message are formed in green, and a fourth design layer 42, in which red dots 43 are formed to fill the insides of the boundaries 33 of the characters, numerals or symbols formed on the third design layer 32, are sequentially placed on the second design layer 22. A fifth design layer 52, in which green dots 53 are formed to fill the insides of the boundaries 63 of the characters, numerals or symbols formed on a sixth design layer 62, and the sixth design layer 62, in which the message that is desired to be communicated by a company and is designed using the boundaries 63 of the red characters, numerals or symbol is formed to effectively hide the prize winning message, are sequentially placed on the fourth design layer 42. As a result, the details of the prize winning message formed on the intermediate design layer cannot be verified with the naked eye, therefore whether prize winning-related details are verified is determined depending on the color of a prize winning verification plate 110 that is provided on-line or off-line.

That is, FIG. 4(a) illustrates a state in which a second design layer 22 is placed on a first design layer 12, FIG. 4(b) illustrates a state in which the second design layer 22 and a third design layer 32 are sequentially placed on the first design layer 12, FIG. 4(c) illustrates a state in which the second design layer 22, the third design layer 32 and a fourth design layer 42 are sequentially placed on the first design layer 12, FIG. 4(d) illustrates a state in which a second design layer 22, the third design layer 32, the fourth design layer 42 and a fifth design layer 52 are sequentially placed on the first design layer 12, and FIG. 4(e) illustrates a state in which second to sixth design layers 20, 30, 40, 50 and 60 are sequentially placed on the first design layer 12. When the magic code 100 fabricated as described above is directly printed on a transparent or opaque printing material 70 or is displayed on a monitor and then the red prize winning verification plate 110 of FIG. 4(f) is placed over the magic code 100, as illustrated in FIG. 4(g), the red color of the magic code remains unchanged and the boundaries 33 of the characters or the like having a complementary color relationship and containing the prize winning-related details have reduced brightness and increased saturation and thus appear black, therefore the details of the prize winning message are exposed to the outside.

Meanwhile, the design layers of the magic code 100 of FIG. 3 are printed using a multiplication method. A multiplication method is a method of adjusting the concentration of the color and tone of an image by stacking the layers of the image one on top of another. The multiplication method is a method of mixing colors using a dye mixing method.

In greater detail, the term “multiplication method” refers to a method of mixing dyes having actual colors. The multiplication method is characterized in that the larger the number of colors is, the closer the resulting color gets to black. The mixing of colors starts with a white background.

Accordingly, when the red dots 43 of the fourth design layer 42 are placed below the green dots 53 of the fifth design layer 52 at the time of stacking, the resulting color is a dark color due to a complementary reaction that takes place first. When the red prize winning verification plate 110 is placed over them later, there is concern that the details of a prize winning message are not exposed to the outside, therefore it is preferred to delete the red dots 43 of the fourth design layer 42 and the dots 53 of the fifth design layer 52 that are placed above or below each other and then place the fifth design layer 52 on the fourth design layer 42.

Here, the color of the prize winning verification plate 110 and the colors of the characters of the design layers are not limited to the above-described combination of colors, but all colors can be used, as long as they can hide prize winning-related details and have a complementary color relationship with each other. The design layers are not limited to those printed on the printing material 70, but they may be stored in a recording medium in the form of electronic files and be provided via the WEB or WAP using a PC, PDA or mobile phone or through Internet E-mail, a cell phone SMS or a cell phone MMS, which are on-line transmission media.

As illustrated in FIGS. 5 and 6, in a magic code for marketing 100 according to still another embodiment of the present invention, a first design layer 14, in which a yellow pattern 13 is regularly and repeatedly formed, and a second design layer 24, in which a red pattern 25 is regularly and repeatedly formed within a specific number of boundaries having the same shape, are sequentially placed on a transparent or opaque printing material 70. A third design layer 34, in which a green pattern 35 is regularly and repeatedly formed within a specific number of boundaries having the same shape, a fourth design layer 44, in which characters, numerals or symbols are formed using green dots 45, and a fifth design layer 54, in which characters, numerals or symbols are formed using red dots 55, are sequentially placed on the second design layer 23. Here, dots 45 of the fourth design layer 44 and dots 55 of the fifth design layer 54 that are placed below or above each other are deleted, and patterns 25 and 35 of the second and third design layers 24 and 34 that are placed below dots 45 and 55 of the fourth and fifth design layer 44 and 54 that remain after the deletion of the dots are also deleted.

That is, FIG. 6(a) illustrates a state in which the second design layer 24 is placed on the first design layer 14, FIG. 6(b) illustrates a state in which the second design layer 24 and the third design layer 34 are sequentially placed on the first design layer 14, FIG. 6(c) illustrates a state in which the second design layer 24, the third design layer 34 and the fourth design layer 44 are sequentially placed on the first design layer 14, and FIG. 6(d) illustrates a state in which the second design layer 24, the third design layer 34, the fourth design layer 44 and the fifth design layer 54 are sequentially placed on the first design layer 14. When the magic code 100 fabricated as described above is directly printed on the transparent or opaque printing material 70 or is displayed on a monitor and the red prize winning verification plate of FIG. 6(e) is placed over the magic code 100 as illustrated in FIG. 6(f), the red color of the magic code 100 remains unchanged, but the brightness and saturation of the green pattern 35 and the green dots 45 having a complementary color relationship with each other are reduced, therefore areas surrounding the hidden characters or numerals appear black, thereby identifying the characters or numerals. In contrast, when the green prize winning verification plate of FIG. 6(g) is placed over the magic code 100 as illustrated in FIG. 6(h), the opposite reaction occurs, therefore characters or numerals different from those in the case where the red prize winning verification plate is placed over the magic code 100, and thus the results vary with the color of the prize winning verification plate 110.

Likewise, the color of the prize winning verification plate 110 and the colors of the design layers 14, 24, 34, 44 and 54 are not limited to the above-described combination of colors, but all colors can be used, as long as they have a complementary color relationship with each other. In the magic code 100 using the transparent printing material 70, the prize winning verification plate 110 may be placed under the magic code 100. In contrast, in the magic code 100 using the opaque printing material 70, whether a prize has been won can be verified when the transparent prize winning verification plate 110 is placed above the magic code 100. Accordingly, unlike the conventional game method, the present method is not limited to the case where the printing material 70 is transparent or translucent. The design layers are not limited to those printed on the printing material 70, but they may be stored in a recording medium in the form of electronic files and be provided using a PC, PDA or mobile phone or through an Internet E-mail via the WEB or WAP, a cell phone SMS or a cell phone MMS, which are on-line transmission media.

Meanwhile, it is preferable to print and fabricate the design layers of the magic code 100 also using a multiplication method.

Furthermore, as illustrated in FIG. 7, a magic code 100 fabricated using at least one of the various methods shown in FIGS. 1 to 6 or a magic code 100 fabricated using at least two of them is formed over a plurality of sections, and the printing colors of design layers vary with the section. When a multi-color prize winning verification plate 110 that corresponds to the magic code 100 having a printing color that varies with the section is placed over the magic code 100, the details of a hidden message are exposed only in the sections of the multi-color prize winning verification plate 110 that have complementary color relationships, therefore whether a prize has been won can be determined, with the result that the ability of the content of an advertisement to attract customers' attention is increased on-line or off-line or customers' participation in a marketing event is encouraged, thereby maximizing the profits of a company.

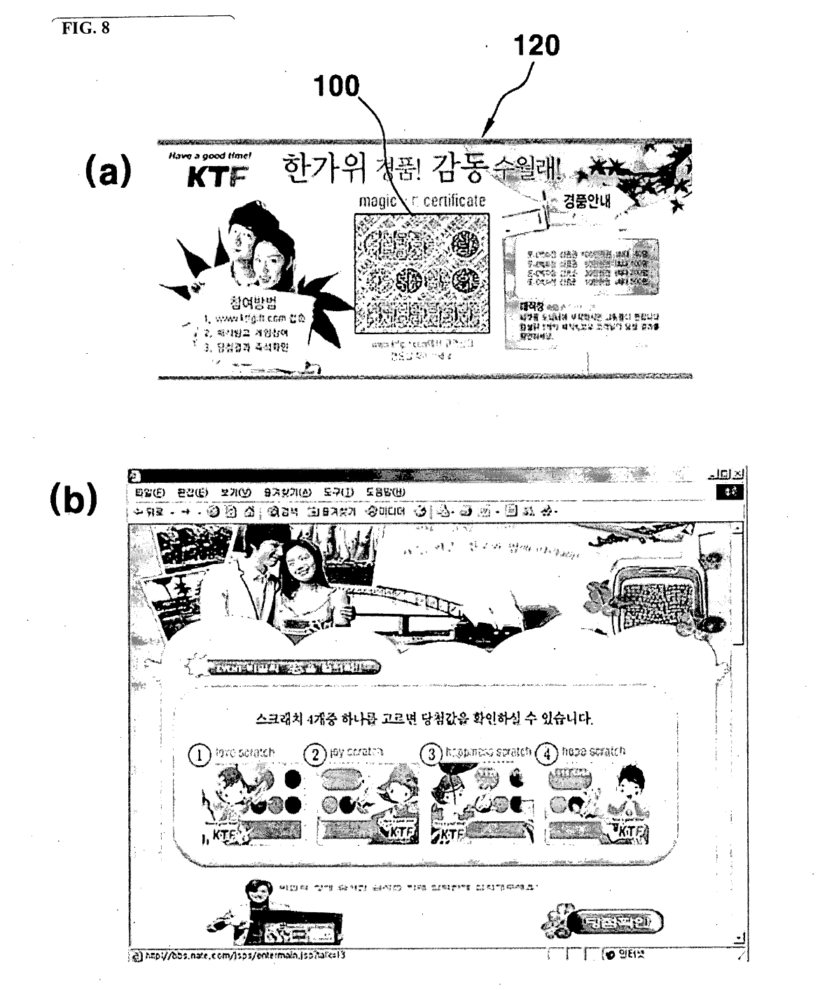

FIGS. 8 to 10 illustrate methods of determining whether a prize has been won using the magic codes according to the present invention on-line or off-line.

As illustrated in FIG. 8, by allowing a user to directly select a magic code 100 or a prize winning verification plate 110 on-line, applying the present invention to a lottery or to bingo, or requiring a gift certificate, including a magic code 100 or a prize winning verification plate 110, to be placed over an Internet web page associated with sports, such as soccer, or a general game, whether a prize has been won can be determined depending on personal ability or good luck upon selection.

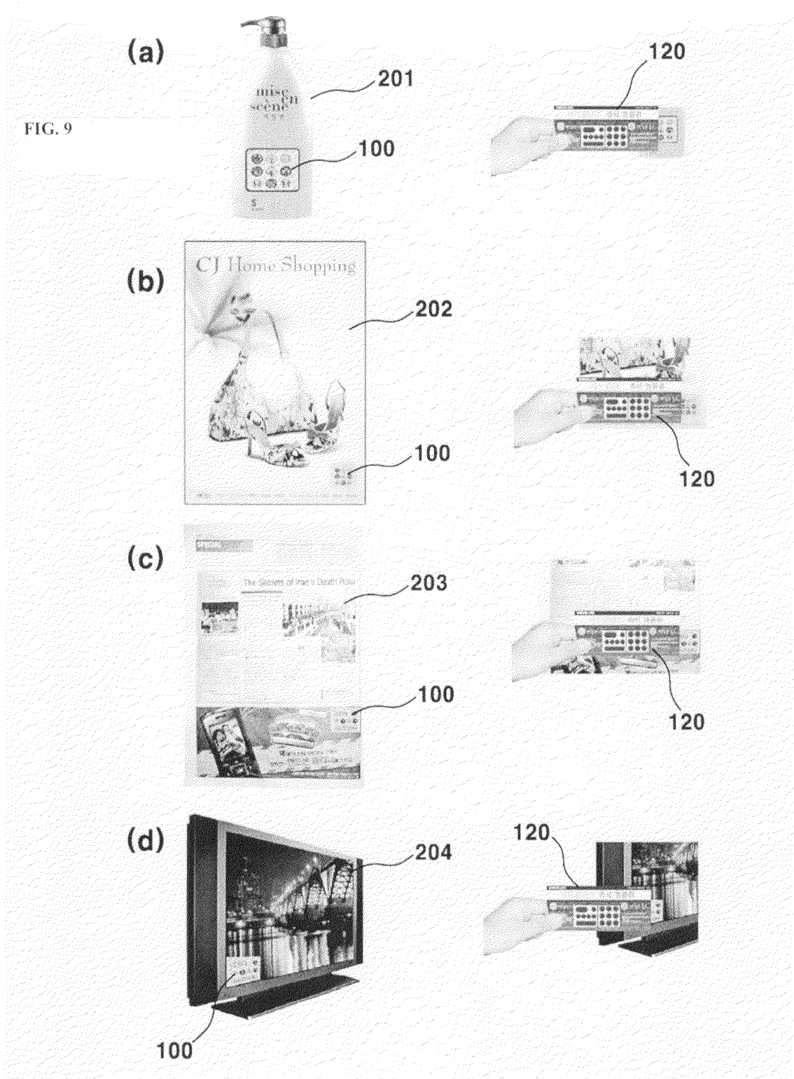

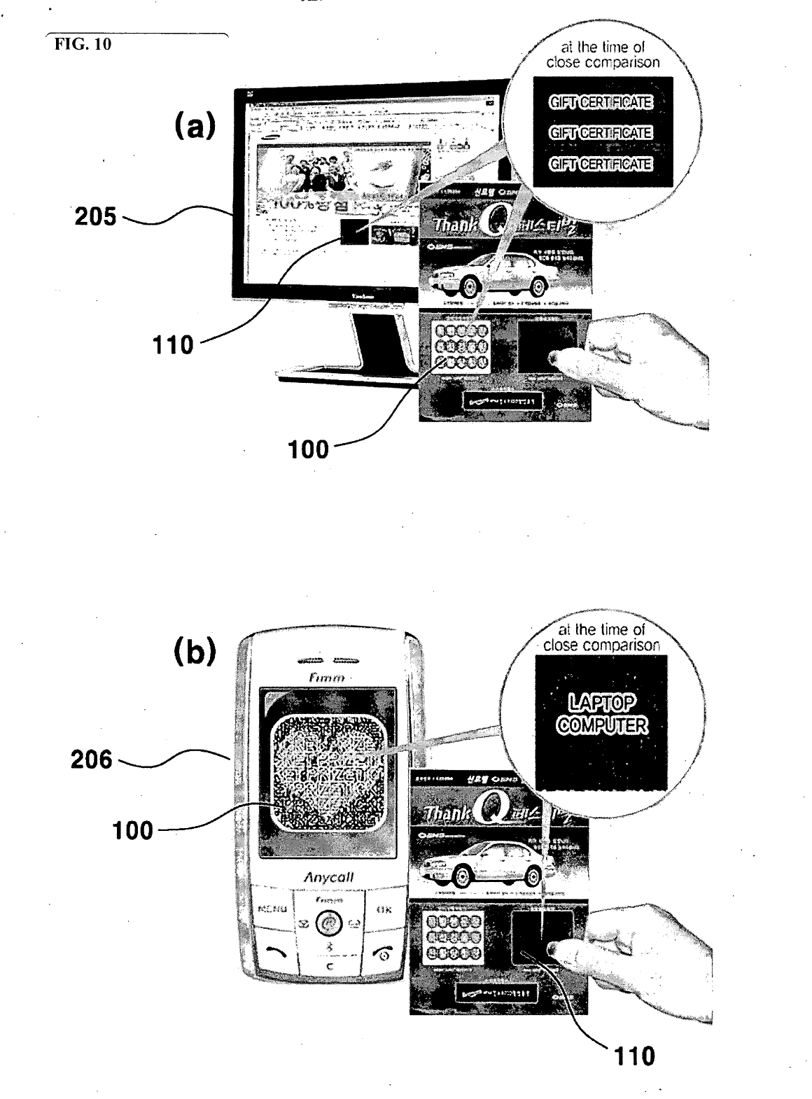

In the methods illustrated in FIGS. 9 and 10, when a gift certificate 120 to which a single color or multi-color prize winning verification plate 110 is attached is fabricated using the various methods of the above-described embodiments and is placed over a magic code 100 that is attached to a product 201, a print medium such as a public relations catalog 202, a promotional coupon, a sticker, a public relationship bill, a product label or a product model, or a newspaper or television advertisement 203 or 204, the details of a prize winning message are exposed based on corresponding complementary color relationships and a prize is presented. Whether a prize has been won can be promptly determined off-line without using various light sources. Moreover, when a gift certificate 120, to which a magic code 100, printed on the transparent printing material using the various methods and forms of the embodiments, or a prize winning verification plate 110 is attached, is placed over a single color or multi-color prize winning verification plate 110 or a magic code 100 that is provided via a wireless communication network, including the wireless Internet, from a prize provision Web site 205 or 206 accessible to a PC, a PDA or a cell phone, prize winning-related details are revealed based on complementary color relationships, and a prize can be provided. Since the color or colors of the single color or multi-color prize winning verification plate 110 are provided and can be changed on-line and a user can select colors, prize winning-related results vary with the color and a various number of cases related to whether a prize has been won are generated, thereby increasing customers' interest therein.

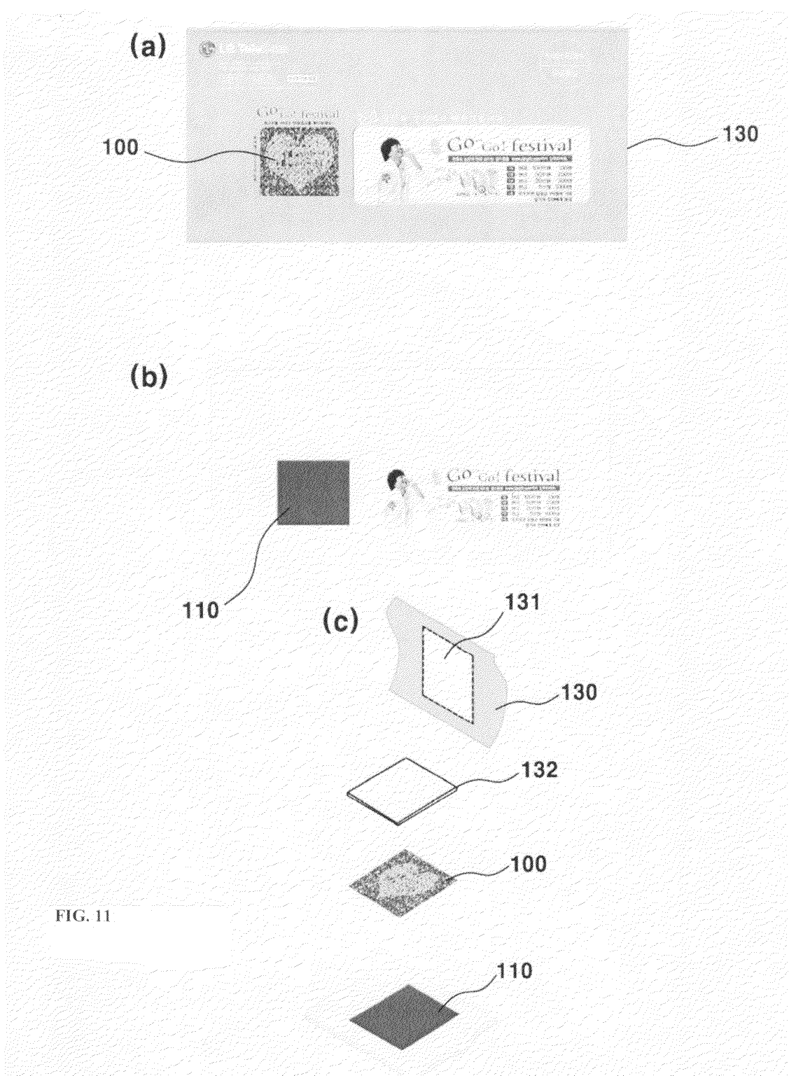

As illustrated in FIG. 11, the magic code according to the present invention is attached to be exposed directly through a see-through window 131 that is formed in the front side of an envelope 130, on which a recipient's name is written, or the front side of wrapping paper, or is attached to the inside of a vinyl patch that is attached around the see-through window 131 and is integrated with the envelope 130 or wrapping paper. Accordingly, after the contents of the envelope 130 or wrapping paper have been removed, the magic code 100 can be placed over the prize winning verification plate 110 that is attached to the inside of the envelope 130 or wrapping paper. Of course, the above-described methods may be used as the game playing method thereof. Furthermore, the prize winning verification plate 110 may be attached to the front side of the envelope 130 or wrapping paper, and the magic code 100 may be attached to the inside thereof.

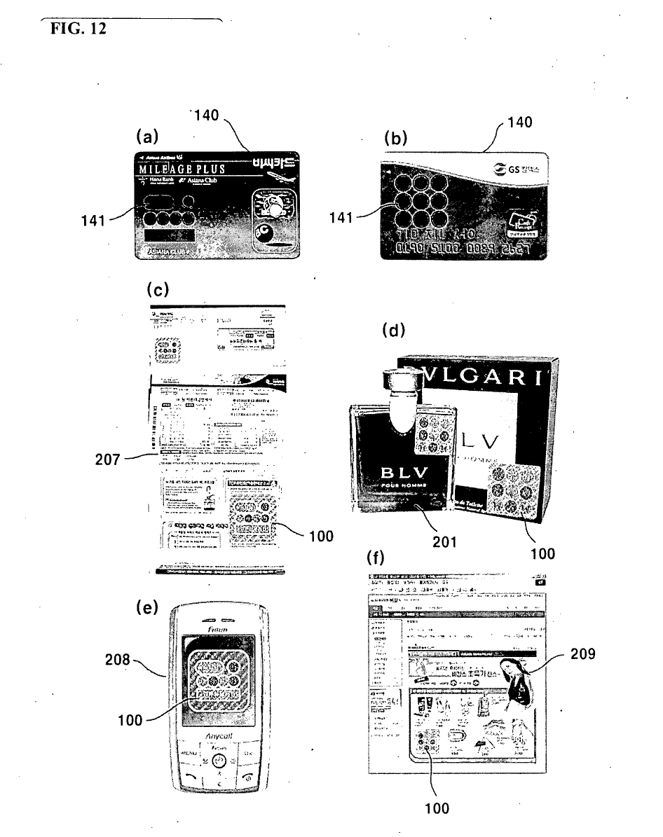

Furthermore, as illustrated in FIG. 12, when a plastic card 140, such as a credit card or membership card, provided with a single color or multi-color transparent window 141 functioning as the prize winning verification plate is provided to a customer, and then the magic code 100 is printed on a postal envelope, a bill 207, a product 201 or various public relations media, or the magic code 100 is transmitted in the form of an electronic file to a PC, a PDA or a cell phone using multi-message service 208 or email 209 via a wireless communication network such as the Internet, the customer can determine whether a prize has been won by placing the plastic card 140 having the transparent window 141 over the magic code 100. Furthermore, the magic code 100 is provided such that it can be changed on-line and a customer can select the changing magic code 100, thereby increasing customers' interest therein.

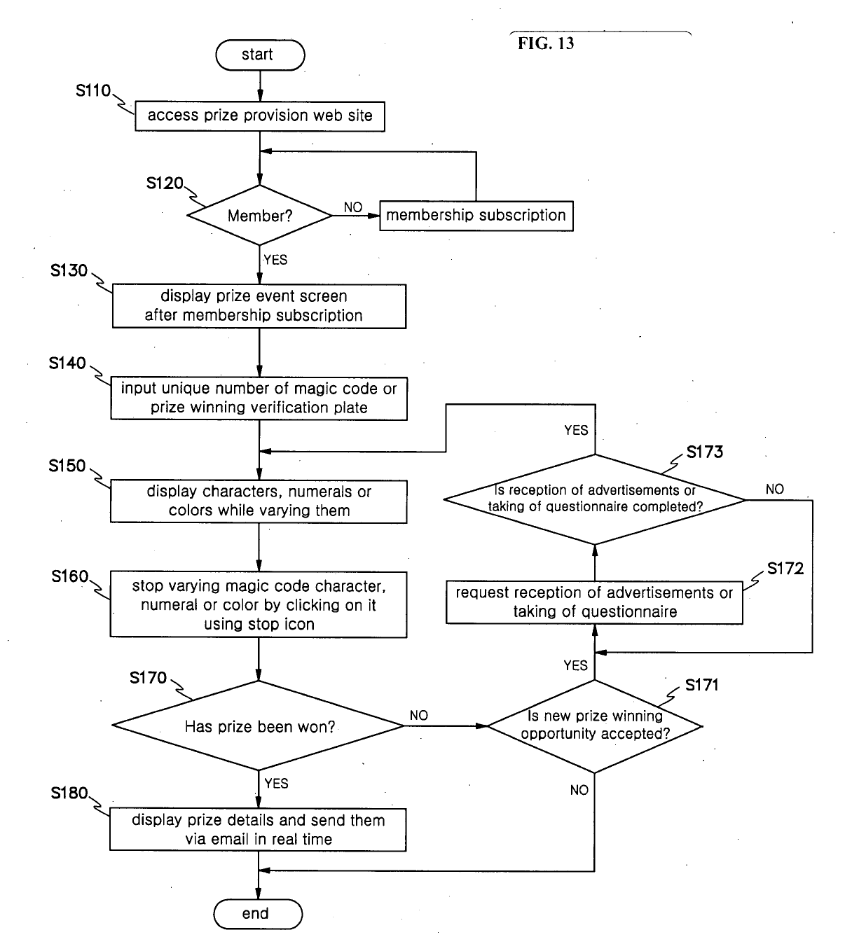

FIG. 13 is a flowchart illustrating an on-line marketing method using a magic code according to an embodiment of the present invention.

As illustrated in FIG. 13, in the on-line marketing method using a magic code, a PC and a communication system, such as a PDA or a cell phone, that is capable of associating a customer with a prize provision web site, email or multi-message service via a means such as the Internet or a wireless communication network, can be used, and the prize provision web site displays a screen and supports the viewing, storage and changing of data through a database.

Furthermore, the on-line marketing method using a magic code provides a web server for allowing a user to determine whether a prize has been won and providing information about a prize winning member, a database for storing information about the membership subscription of a customer and a unique number transmitted from the web server, and a streaming server for streaming information via a communication network in real time.

First, various types of magic codes 100 or prize winning verification plates 110 provided by the present invention are distributed on/off-line, and customers acquiring them access a prize provision web site, email or multi-message service via the Internet or a wireless communication network at step S110.

In the case of a customer accessing the prize provision web site, when the customer selects a prize winning event, the prize provision web site determines whether the customer has subscribed to membership and prompts the customer to subscribe to membership at step S120. Here, the web server of the prize provision web site receives the customer's request for membership subscription via a communication network, receives information about the customer's name, address, telephone number, user ID and user password, causes it to be stored in the database, analyzes the customer's information, and uses the analysis results in target marketing.

If, using the database, it is determined that the customer has subscribed to membership, a prize event screen in which the prize winning verification plate 110 or magic code 100 and a unique number input box are created is displayed at step S130. Here, when the web server is accessed using a user ID and a password, a graphic interface provides information about a prize event to the customer's communication system.

The user is prompted to input the unique number of the magic code 100 or prize winning verification plate 110 acquired by the customer through the unique number input box of the prize event screen at step S140. At this time, the database has stored information about the customer's membership subscription and the unique number transferred from the web server, and the prize provision web site authenticates the unique number input by the customer by comparing the unique number with the content stored in the database.

The characters, numerals or colors of the magic code 100 or prize winning verification plate 110 shown on the screen of the prize event may be displayed and vary at step S150. In this case, it is preferable to stream the process of varying the characters, numerals or colors using the streaming server via a network in real time so as to determine whether a prize has been won. If the customer clicks on and stops the varying characters, numerals or colors using a stop icon at step S160, the characters, numerals or colors selected using the stop icon are sent to the web server via the network.

Meanwhile, in the case where the prize winning verification plate 110 is displayed on the screen of the prize event, the customer may determine whether a prize has been won by placing the magic code 100 over the prize winning verification plate 110. In contrast, in the case where the magic code 100 is displayed on the screen of the prize event, the customer may determine whether a prize has been won by placing the acquired prize winning verification plate 110 over the magic code 100 at step S170. Here, when the determination of whether a prize has been won is completed, the web server extracts prize winning information through the use of the database based on the input of the unique number, displays information about whether the customer has won a prize on a screen, and requests the customer to check the information.

If no prize has been won, the web server of the prize provision web site may inquire about whether the customer will accept a new opportunity to win a prize from the customer's communication system at step S171. A customer who accepts the new opportunity may be requested to receive advertisements stored in the web server for a specific time period or to take questionnaires at steps S172-S173. Here, the web server may receive answers to the questionnaire from the customer's communication system, store the answers in the database, and use them as materials for future target marketing.

Meanwhile, a prize winning verification plate 110 or magic code 100 is displayed only to the customer who has consumed the advertisement or has taken the questionnaire, and the customer is allowed to place the acquired magic code 100 or prize winning verification plate 1 10 over the prize winning verification plate 110 or magic code 100 again, thereby determining whether a prize has been won at steps S150-S170.

When whether a prize related to the magic code 100 has been won is finally determined, the web server of the prize provision web site displays the details of the prize on a screen and, at the same time, reads information about the customer from the database in which the information was stored at the time of membership subscription and sends information about the details of the prize to the customer's email address in real time at step S180. At the time of sending the information to the customer's email address, the prize provision web site may send an advertisement along with the details of the prize.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed:

1. A magic code for marketing, comprising:
a second design layer in which a character, numeral or symbol pattern is regularly and repeatedly formed in a specific color on a black design substrate and character, numeral or symbol patterns placed below a prize winning message are deleted;
a third design layer in which boundaries of character, numeral or symbol patterns containing a prize winning message are formed in a color similar to the color of the character, numeral or symbol patterns of the second design layer;
a fourth design layer in which dots are formed in a color having a complementary color relationship with the color of the character, numeral or symbol patterns of the second design layer so as to fill insides of the boundaries of the character, numeral or symbol patterns that are formed on the third design layer;
a fifth design layer in which dots are formed in a color similar to the color of the character, numeral or symbol patterns of the second design layer so as to fill an inside of a boundary of a character, numeral or symbol pattern that is formed on a sixth design layer; and
the sixth design layer in which the boundary of the character, numeral or symbol pattern is regularly and repeatedly formed in a color similar to the color of the dots of the fourth design layer so as to effectively hide the prize winning message;
wherein the second, third, fourth, fifth and sixth layers are sequentially stacked one on top of another based on brightness, saturation and complementary color relationships, therefore details of the prize winning message of the intermediate design layer cannot be verified with a naked eye.

2. A magic code for marketing, comprising:
a first design layer in which a pattern is regularly and repeatedly formed in a specific color;
a second design layer in which a pattern is regularly and repeatedly formed in two colors having a complementary color relationship with each other, and patterns that are respectively placed below a message of a third design layer and a message of a sixth design layer are deleted;
the third design layer in which boundaries of characters, numerals or symbols, containing a prize winning message, are formed in one of the two colors of the pattern of the second design layer;
a fourth design layer in which dots are formed in a color having a complementary color relationship with the color of the boundaries of the characters, numerals or symbols of the third design layer so as to fill insides of the boundaries of the characters, numerals or symbols of the third design layer;
a fifth design layer in which dots are formed in a color similar to the color of the boundaries of the characters, numerals or symbols of the third design layer so as to fill insides of boundaries of characters, numerals or symbols formed on a sixth design layer; and
the sixth design layer in which a message, which is desired to be communicated by a corporation and is designed using the boundaries of the characters, numerals, or symbols, is formed in a color similar to the color of the dots of the fourth design layer so as to effectively hide the prize winning message;
wherein the first, second, third, fourth, fifth and sixth layers are sequentially stacked one on top of another based on brightness, saturation and a complementary color relationship, so that details of the prize winning message of the intermediate design layer cannot be verified with a naked eye.

3. A magic code for marketing, comprising:
a first design layer in which a pattern is regularly and repeatedly formed in a specific color;
a second design layer in which a pattern is regularly and repeatedly formed in a specific number of identically shaped boundaries in a specific color;
a third design layer in which a pattern is regularly and repeatedly formed in a specific number of identically shaped boundaries in a color having a complementary color relationship with the color of the pattern of the second design layer;
a fourth design layer in which characters, numerals or prize symbols are formed of dots having a color similar to the color of the pattern of the third design layer; and
a fifth design layer in which characters, numerals or prize symbols are formed of dots having a color similar to the color of the pattern of the third design layer;
wherein the first, second, third, fourth, and fifth design layers are sequentially stacked one on top of another, dots of the fourth design layer and dots of the fifth design layer that are placed below or above each other are deleted, and patterns of the second and third design layers that are placed below dots of the fourth and fifth design layer that remain after the deletion of the dots are also deleted, so that a varying message appears according to situation.

4. The magic code as set forth in claim 1, wherein the magic code is divided into a plurality of sections and different printing colors are applied to the respective sections of the design layers of the magic code, so that, when a multi-color prize winning verification plate configured to correspond to the magic code with the different printing colors applied to the respective sections thereof is placed over the magic code, the details of the hidden message are exposed only in sections of the magic code having complementary color relationships with the multi-color prize winning verification plate.

5. The magic code as set forth in claim 2, wherein the magic code is divided into a plurality of sections and different printing colors are applied to the respective sections of the design layers of the magic code, so that, when a multi-color prize winning verification plate configured to correspond to the magic code with the different printing colors applied to the respective sections thereof is placed over the magic code, the details of the hidden message are exposed only in sections of the magic code having complementary color relationships with the multi-color prize winning verification plate.

6. The magic code as set forth in claim 3, wherein the magic code is divided into a plurality of sections and different printing colors are applied to the respective sections of the design layers of the magic code, so that, when a multi-color prize winning verification plate configured to correspond to the magic code with the different printing colors applied to the respective sections thereof is placed over the magic code, the details of the hidden message are exposed only in sections of the magic code having complementary color relationships with the multi-color prize winning verification plate.

7. A complex magic code in which the magic codes set forth in claim 1 are mixed with each other, wherein the magic code is divided into a plurality of sections and different printing colors are applied to the respective sections of the design layers of the magic code, so that, when a multi-color prize winning verification plate configured to correspond to the magic code with the different printing colors applied to the respective sections thereof is placed over the magic code, the details of the hidden message are exposed only in sections of the magic code having complementary color relationships with the multi-color prize winning verification plate.

8. A complex magic code in which the magic codes set forth in claim 2 are mixed with each other, wherein the magic code is divided into a plurality of sections and different printing colors are applied to the respective sections of the design layers of the magic code, so that, when a multi-color prize winning verification plate configured to correspond to the magic code with the different printing colors applied to the respective sections thereof is placed over the magic code, the details of the hidden message are exposed only in sections of the magic code having complementary color relationships with the multi-color prize winning verification plate.

9. A complex magic code in which the magic codes set forth in claim 3 are mixed with each other, wherein the magic code is divided into a plurality of sections and different printing colors are applied to the respective sections of the design layers of the magic code, so that, when a multi-color prize winning verification plate configured to correspond to the magic code with the different printing colors applied to the respective sections thereof is placed over the magic code, the details of the hidden message are exposed only in sections of the magic code having complementary color relationships with the multi-color prize winning verification plate.

10. The magic code as set forth in claim 1, wherein the magic code can be combined with on-line games, such as a selection game, a score game, an amusement game, a lotto game and a bingo game, so that prize winning results are determined depending on personal ability or good luck upon selection when a customer determines whether a prize has been won.

11. The magic code as set forth in claim 2, wherein the magic code can be combined with on-line games, such as a selection game, a score game, an amusement game, a lotto game and a bingo game, so that prize winning results are determined depending on personal ability or good luck upon selection when a customer determines whether a prize has been won.

12. The magic code as set forth in claim 3, wherein the magic code can be combined with on-line games, such as a selection game, a score game, an amusement game, a lotto game and a bingo game, so that prize winning results are determined depending on personal ability or good luck upon selection when a customer determines whether a prize has been won.

14. An advertisement medium, wherein the magic code set forth in claim 1, or a plurality of magic codes are mixed with each other, is inserted into a print medium, such as a promotional coupon, a sticker, an advertising bill, an advertising catalog, a product label or a product model, an advertisement medium, such as a television, a newspaper or a magazine, a web page, a cell phone WAP page, a product, or a printed material, such as product wrapping paper, a case, or a bill.

15. An advertisement medium, wherein the magic code set forth in claim 2, or a plurality of magic codes are mixed with each other, is inserted into a print medium, such as a promotional coupon, a sticker, an advertising bill, an advertising catalog, a product label or a product model, an advertisement medium, such as a television, a newspaper or a magazine, a web page, a cell phone WAP page, a product, or a printed material, such as product wrapping paper, a case, or a bill.

16. An advertisement medium, wherein the magic code set forth in claim 3, or a plurality of magic codes are mixed with each other, is inserted into a print medium, such as a promotional coupon, a sticker, an advertising bill, an advertising catalog, a product label or a product model, an advertisement medium, such as a television, a newspaper or a magazine, a web page, a cell phone WAP page, a product, or a printed material, such as product wrapping paper, a case, or a bill.

17. An advertisement medium, wherein the magic code set forth in claim 1 or a plurality of magic codes are mixed with each other, is implemented in a web page or WAP page provided through a Personal Computer (PC), a mobile phone or a Personal Digital Assistant (PDA) in electronic file form, or is inserted into Internet email or a Multimedia Message Service (MMS) message, which is an on-line transmission medium.

18. An advertisement medium, wherein the magic code set forth in claim 2 or a plurality of magic codes are mixed with each other, is implemented in a web page or WAP page provided through a Personal Computer (PC), a mobile phone or a Personal Digital Assistant (PDA) in electronic file form, or is inserted into Internet email or a Multimedia Message Service (MMS) message, which is an on-line transmission medium.

19. An advertisement medium, wherein the magic code set forth in claim 3 or a plurality of magic codes are mixed with each other, is implemented in a web page or WAP page provided through a Personal Computer (PC), a mobile phone or a Personal Digital Assistant (PDA) in electronic file form, or is inserted into Internet email or a Multimedia Message Service (MMS) message, which is an on-line transmission medium.

20. An advertisement medium, wherein the magic code set forth in claim 1, or a plurality of magic codes are mixed with each other, is attached be exposed directly through a see-through window that is formed in a front side of an envelope, on which a recipient's name is written, or a front side of wrapping paper, or is attached to an inside of a vinyl patch that is attached around the see-through window and is integrated with the envelope or wrapping paper, so that, after contents of the envelope or wrapping paper have been removed, the magic code can be placed over the prize winning verification plate that is attached to the inside of the envelope or wrapping paper.

21. An advertisement medium, wherein the magic code set forth in claim 2, or a plurality of magic codes are mixed with each other, is attached be exposed directly through a see-through window that is formed in a front side of an envelope, on which a recipient's name is written, or a front side of wrapping paper, or is attached to an inside of a vinyl patch that is attached around the see-through window and is integrated with the envelope or wrapping paper, so that, after contents of the envelope or wrapping paper have been removed, the magic code can be placed over the prize winning verification plate that is attached to the inside of the envelope or wrapping paper.

22. An advertisement medium, wherein the magic code set forth in claim 3, or a plurality of magic codes are mixed with each other, is attached be exposed directly through a see-through window that is formed in a front side of an envelope, on which a recipient's name is written, or a front side of wrapping paper, or is attached to an inside of a vinyl patch that is attached around the see-through window and is integrated with the envelope or wrapping paper, so that, after contents of the envelope or wrapping paper have been removed, the magic code can be placed over the prize winning verification plate that is attached to the inside of the envelope or wrapping paper.

23. A plastic card medium, wherein a single color or multi-color transparent window functioning as a prizing winning verification plate is provided to verify prizing winning for the magic code set forth in claim 1, or a plurality of magic codes are mixed with each other, which is printed on a postal envelope, a bill, a product or various advertising media, or which is transmitted via a wireless communication network, such as an Internet, to a PC, a PDA or a cell phone using a MMS or email method in electronic file form.

24. A plastic card medium, wherein a single color or multi-color transparent window functioning as a prizing winning verification plate is provided to verify prizing winning for the magic code set forth in claim 2, or a plurality of magic codes are mixed with each other, which is printed on a postal envelope, a bill, a product or various advertising media, or which is transmitted via a wireless communication network, such as an Internet, to a PC, a PDA or a cell phone using a MMS or email method in electronic file form.

25. A plastic card medium, wherein a single color or multi-color transparent window functioning as a prizing winning verification plate is provided to verify prizing winning for the magic code set forth in claim 3, or a plurality of magic codes are mixed with each other, which is printed on a postal envelope, a bill, a product or various advertising media, or which is transmitted via a wireless communication network, such as an Internet, to a PC, a PDA or a cell phone using a MMS or email method in electronic file form.
